(19) United States
(12) Patent Application Publication
(10) Pub. No.: US 2024/0350363 A1
(43) Pub. Date: Oct. 24, 2024

(54) PORTABLE TEMPERATURE CONTROLLED BAG WITH SECURELY MOUNTED UNPOWERED COOLING DEVICE

(71) Applicant: TRITON SYSTEMS, INC., Chelmsford, MA (US)

(72) Inventors: Abigail MCADAMS, Medford, MA (US); Timothy FERREIRA, Nashua, NH (US); Tyson LAWRENCE, Highlands Ranch, CO (US)

(21) Appl. No.: 18/642,401

(22) Filed: Apr. 22, 2024

Related U.S. Application Data
(60) Provisional application No. 63/497,616, filed on Apr. 21, 2023.

(51) Int. Cl. A61J 1/16; B65D 81/02; B65D 81/18; B65D 81/38

(52) U.S. Cl. CPC A61J 1/165; B65D 81/022; B65D 81/18; B65D 81/3893; B65D 81/3897

(57) ABSTRACT

The present disclosure describes a temperature controlled bag comprising an unpowered cooling device and a bag. The bag includes an insulated chamber defining a cavity to be cooled, a protective layer exterior to the insulated chamber, and an outer fabric shell. A strap is utilized to secure the cooling device in place with a sealing amount of pressure to engage a gasket, ensuring efficient cooling performance. The innovative design of this temperature controlled bag provides effective cooling capabilities while maintaining a compact and portable structure, making it ideal for various cooling applications. Also disclosed is an absorptive cooling device which may include a reservoir configured to contain a fluid. The device may further include an evaporator adjacent to an object to be cooled and an adsorber including a metal-organic framework adsorbent, wherein the device is not connected to a power source. Methods of cooling an object using the device are also described.

This application claims benefit of priority to U.S. provisional patent application No. 63/497,616 entitled LONG DURATION NON-POWERED ADSORBENT COOLING filed Apr. 21, 2023 the entirety of which is hereby incorporated by reference.

### GOVERNMENT SPONSORSHIP

This invention was made with government support under contract number W81XWH-21-P-0109 awarded by the Defense Health Agency. The government has certain rights in the invention.

### FIELD

The present disclosure relates generally to non-powered, temperature-controlled devices. More particularly, the incorporation of adsorption cooling devices into bags, rucksacks, backpacks, and other portable bags allowing temperature-sensitive materials to be easily carried while maintaining a desired temperature without requiring access to refrigeration prior to use. In some aspects, this disclosure relates to the use of metal-organic frameworks in cooling devices.

### BACKGROUND

There is a need for easy to carry reliable, long-duration temperature-controlled bag, such as medic bags for the transportation and storage of perishable items and sensitive materials such as blood, vaccines, and other medical products in austere locations without access to refrigeration or power. Traditional insulated medic bags use solid-liquid phase change technology, which provides limited cooling potential per unit weight, and requires the phase change material to be provided in a frozen state. This means the user must have access to a freezer and wait up to 24 hours for their phase change material, generally ice, to freeze. Further, once the ice in the insulated bag has melted the user must return to the freezer, temperature controlled bag

Alternative cooling approaches have been attempted using a power source, such as a battery, and methods to provide cooling using electricity such as thermoelectric or Peltier junctions and mechanical-compression refrigeration cycles but these add significantly to the weight and complexity of the system and increase safety risk while in transit.

There remains a need for temperature controlled bags that offer long duration cooling without requiring access to a freezer prior to use or adding significant weight or volume. One such strategy is the design of a robust and easily carried bag that incorporates an adsorption cooling device that can be activated to evaporate a coolant fluid and absorb heat based on the latent heat of vaporization of the chosen fluid. The heat cooling effect is limited by the vapor uptake capacity of the adsorbent. The used cooling device would then generally be discarded and a replaced with a new adsorbent cooling engine. The bag should be designed for easy exchange of cooling engines and may include accommodation to carry additional cooling engines.

### SUMMARY

Some embodiments provide a temperature controlled bag including: including an insulated chamber defining a cavity to be cooled, a protective layer exterior to the insulated chamber, and an outer fabric shell, and an unpowered cooling device wherein the cooling device is mounted to edges at an opening of the insulated chamber with a sealing gasket therebetween, and a strap used to secure the cooling device in place with a sealing amount of pressure to engage the gasket.

Some embodiments provide a temperature controlled bag, further including an adapter between the cooling engine and the insulated chamber to accommodate differences in size

Some embodiments provide a temperature controlled bag, wherein the unpowered cooling device is an adsorptive cooler.

Some embodiments provide a temperature controlled bag, wherein the unpowered cooling device is an adsorptive cooler utilizing a metal organic framework adsorbent to increase cooling capacity relative to weight and/or volume. Such cooling engines may be capable of maintaining blood preservation temperatures for 3 days or more.

Some embodiments provide a temperature controlled bag, wherein the insulative chamber further includes one or more VIP panels.

Some embodiments provide a temperature controlled bag, wherein the protective layer includes a material having one or more of the following features: shock resistance, puncture resistance, water resistance, chemical resistance, and rip stop.

Some embodiments provide a temperature controlled bag, further including an adapter between the cooling engine and the insulated chamber to accommodate differences in size; and wherein the unpowered cooling device is an adsorptive cooler capable of maintaining blood preservation temperatures for at least 3 days; the insulative chamber further includes one or more VIP panels; and the protective layer includes a material having one or more of the following features: shock resistance, puncture resistance, water resistance, chemical resistance, and rip stop.

In some aspects, the techniques described herein relate to a device for cooling an object, including: a reservoir configured to contain a fluid, an evaporator adjacent to an object to be cooled, and an adsorber including a metal-organic framework adsorbent, wherein the device is not connected to a power source.

In some aspects, the techniques described herein relate to a device, wherein the fluid includes water.

In some aspects, the techniques described herein relate to a device, wherein the reservoir is connected to the evaporator by a conduit including a wicking material.

In some aspects, the techniques described herein relate to a device, wherein the conduit further includes a valve.

In some aspects, the techniques described herein relate to a device, wherein the metal-organic framework adsorbent includes zirconium, aluminum, titanium, hafnium, chromium, iron, manganese, indium, 3,3″,5,5″-tetrakis(4-carboxyphenyl)-p-terphenyl, 1,4-benzene dicarboxylate (TPA), bis(1H-1,2,3-triazolo[4,5-b],[4′,5′-i])dibenzo-[1,4]dioxin, 1,3,5-benzene tricarboxylate, 1,2,4,5-tetrakis(4-carboxyphenyl)benzene, 4,4′,4″,4′″-methanetetrayltetrabenzoate, 3,5-pyrazoledicarboxylate, fumarate, 3,3′,5,5′-tetracarboxydiphenylmethane, 2,5-thiophenedicarboxylate, 2,5-furandicarboxylate, or combinations thereof.

In some aspects, the techniques described herein relate to a device, wherein the metal organic framework adsorbent comprises UiO-66, MOF-303, MOF-808, PIZOF-2UiO-66, MIL-101(Cr)PIZOF-2, MOF-76, ZIF-67, MOF-3, MOF-5, MIL-101-ED, PCN-222, La-PDA, Cr-soc-MOF-1, MIL-101(Cr), CO2Cl2(BTDD), MIL-100(Fe), MOF-841(Zr), Y-shp-MOF-5, MOF-303(Al), MIL-125(Ti)—NH₂, Aluminum-fumarate, MIP-200(Zr), CAU-23(Al), MIL-53(Al)—OH, MIL-160(Al), CAU-10(Al)—H, UiO-66(Zr), MOF-801(Zr), or combinations thereof.

In some aspects, the techniques described herein relate to a device, wherein the adsorbent further includes a hygroscopic salt.

In some aspects, the techniques described herein relate to a device, wherein the hygroscopic salt includes calcium chloride (CaCl₂), lithium chloride (LiCl), lithium bromide (LiBr), magnesium chloride (MgCl₂), calcium nitrate (Ca(NO₃)₂), potassium fluoride (KF), phosphorous pentoxide (P₂O₅), magnesium perchlorate (Mg(ClO₄)₂), barium oxide (BaO), calcium oxide (CaO), calcium sulfate (CaSO₄), aluminum oxide (Al₂O₃), calcium bromide (CaBr₂), barium perchlorate (Ba(ClO₄)₂), copper sulfate (CuSO₄), or combinations thereof.

In some aspects, the techniques described herein relate to a device, wherein the adsorbent has a vapor uptake capacity of at least about 40 wt. %.

In some aspects, the techniques described herein relate to a device, wherein the adsorbent has a vapor uptake capacity of at least about 60 wt. %.

In some aspects, the techniques described herein relate to a device, wherein the adsorbent has a vapor uptake capacity of at least about 90 wt. %.

In some aspects, the techniques described herein relate to a device, wherein the adsorber is separated from the evaporator by a porous insulating layer.

In some aspects, the techniques described herein relate to a method, including: transferring the fluid from the reservoir to an evaporator, wherein the evaporator which is under vacuum evaporates the fluid to form a vapor, thereby lowering the temperature of the fluid in the evaporator which cools the object, and transferring the vapor to an adsorber including a metal-organic framework adsorbent which adsorbs the vapor, thereby increasing the temperature of the adsorber, wherein heat is transferred from the adsorber to an environment surrounding the adsorber when the temperature of the adsorber exceeds the temperature of the environment.

In some aspects, the techniques described herein relate to a method of cooling an object, including: providing a fluid in a reservoir, transferring the fluid from the reservoir to an evaporator which is adjacent to the object, wherein the evaporator which is under vacuum evaporates the fluid to form a vapor, thereby lowering the temperature of the fluid in the evaporator which cools the object, and transferring the vapor to an adsorber including a metal-organic framework which adsorbs the vapor, thereby increasing the temperature of the adsorber, wherein heat is transferred from the adsorber to an environment surrounding the adsorber when the temperature of the adsorber exceeds the temperature of the environment.

In some aspects, the techniques described herein relate to a method, wherein the fluid is water.

In some aspects, the techniques described herein relate to a method, wherein the metal-organic framework includes zirconium, aluminum, titanium, hafnium, chromium, iron, manganese, indium, 3,3″,5,5″-tetrakis(4-carboxyphenyl)-p-terphenyl, 1,4-benzene dicarboxylate (TPA), bis(1H-1,2,3-triazolo[4,5-b],[4′,5′-i])dibenzo-[1,4]dioxin, 1,3,5-benzene tricarboxylate, 1,2,4,5-tetrakis(4-carboxyphenyl)benzene, 4,4′,4″,4′″-methanetetrayltetrabenzoate, 3,5-pyrazoledicarboxylate (for MOF-303(Al)), fumarate, 3,3′,5,5′-tetracarboxydiphenylmethane, 2,5-thiophenedicarboxylate, 2,5-furandicarboxylate, or combinations thereof.

In some aspects, the techniques described herein relate to a method, wherein the metal organic framework adsorbent comprises UiO-66, MOF-303, MOF-808, PIZOF-2UiO-66, MIL-101(Cr)PIZOF-2, MOF-76, ZIF-67, MOF-3, MOF-5, MIL-101-ED, PCN-222, La-PDA, Cr-soc-MOF-1, MIL-101(Cr), CO2Cl2(BTDD), MIL-100(Fe), MOF-841(Zr), Y-shp-MOF-5, MOF-303(Al), MIL-125(Ti)—NH₂, Aluminum-fumarate, MIP-200(Zr), CAU-23(Al), MIL-53(Al)—OH, MIL-160(Al), CAU-10(Al)—H, UiO-66(Zr), MOF-801(Zr), or combinations thereof.

In some aspects, the techniques described herein relate to a method, wherein the adsorber further includes a hygroscopic salt.

In some aspects, the techniques described herein relate to a method, wherein the adsorber has a vapor uptake capacity of at least about 60 wt. %.

In some aspects, the techniques described herein relate to a method, wherein the adsorber has a vapor uptake capacity of at least about 90 wt. %.

In some aspects, the techniques described herein relate to a method, wherein the object can be cooled for a time of about 1 day to about 10 days.

In some aspects, the techniques described herein relate to a method, wherein cooling of the object ends when the reservoir is emptied of fluid.

In some aspects, the techniques described herein relate to a method, wherein cooling of the object does not utilize a power source.

In some aspects, the techniques described herein relate to a temperature controlled bag, which includes a chamber defining an interior space to be cooled; a cooling device in accordance with any of the embodiments disclosed herein, wherein the cooling device is fluidly connected with the interior space of the chamber to facilitate cooling the interior space and any contents contained therein.

### DRAWINGS

Aspects, features, benefits, and advantages of the embodiments described herein will be apparent with regard to the following description, appended claims, and accompanying drawings where:

FIG. 1 is a perspective view of a temperature controlled bag in accordance with some embodiments.

FIG. 2 is a cross-sectional view of the system depicted in FIG. 1, showing the construction layers of the system.

FIG. 3 depicts a similar cross-section with the outer fabric shell lid 412 in a closed position.

FIG. 4 is another cross-section view illustrating a system in accordance with some embodiments.

FIG. 5 depicts a cross-section of an embodiment which include a second additional layer of insulative panels 200b.

FIG. 6 is a perspective view depicting a chamber lid 160 for the insulated bag 200, where the chamber lid incorporates an adapter 152, a gasket 152, and a cooling device 100.

FIG. 7. is a cross-sectional view of the chamber lid of FIG. 6.

FIG. 8 is a perspective exterior view of a system in accordance with some embodiments, depiciting option should straps and handle as well as molle straps.

FIG. 9 is a perspective view of one embodiment of the system disclosed, in a fully closed arrangement.

FIG. 10 is a perspective view of one embodiment of the system disclosed, with outer lid remove and showing a strap holding the cooling device in place.

FIG. 11 is a perspective view of one embodiment of the system disclosed, showing the interior cooling cavity defined by the insulative panels, protective liner, and outer fabric shell

FIG. 12 is an illustrative diagram of a device for cooling an object, according to an embodiment of the present disclosure.

FIG. 13 is a graph comparing the vapor uptake capacity of a metal-organic framework adsorber compared to a silica-based adsorber.

FIG. 14 is a graph showing the uptake capacity of a metal-organic framework alone compared to a metal-organic framework impregnated with calcium chloride.

### DETAILED DESCRIPTION

Generally speaking, disclosed herein is a system for containing products that must be kept at cooler temperatures preferably for transport. The systems described herein are particularly well-suited for military field operations and medical samples, tissues, and/or supplies, such as but not limited to blood samples, blood supplies, etc.

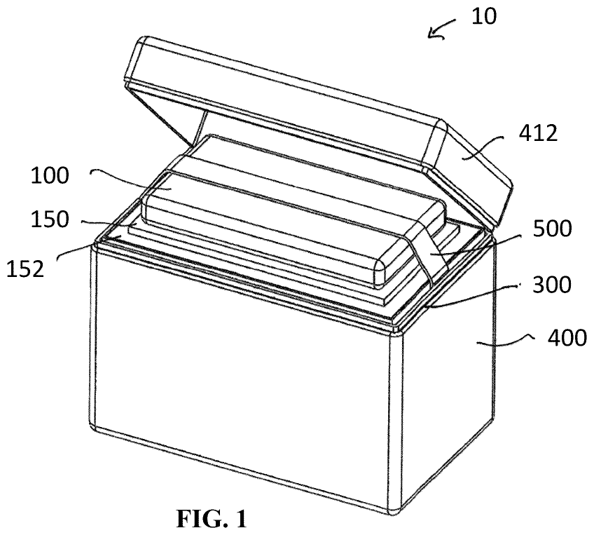

FIG. 1 is a perspective view of a temperature controlled bag in accordance with some embodiments. Generally speaking the overall system includes an unpowered cooling device 100, an insulated chamber 200 defining a cavity to be cooled, a protective layer 300 exterior to the insulated chamber, and an outer fabric shell 400, where the cooling device 100 is mounted to the edges at the opening of the insulated chamber 200 with a sealing gasket 150 therebetween, and a strap 500 used to secure the cooling device 100 in place with a sealing amount of pressure to engage the gasket. An adapter 152 may be used between the cooling engine 100 and the insulated chamber 200 to accommodate differences in size. It will be appreciated that a gasket can be employed between the cooling engine and the adapter as well as between the adapter and the insulated chamber.

The terms “cooling engine” and “cooling device” are used interchangeably throughout this disclosure.

The system shown throughout the figures represents a singular design having a top opening and separate lid. This arrangement has been maintained throughout for ease of disclosure. Other arrangements are possible. For example, the system could take the form of a shoulder bag with a top or front opening/lid; a backpack with a zippered front panel as a lid, or any other suitable form.

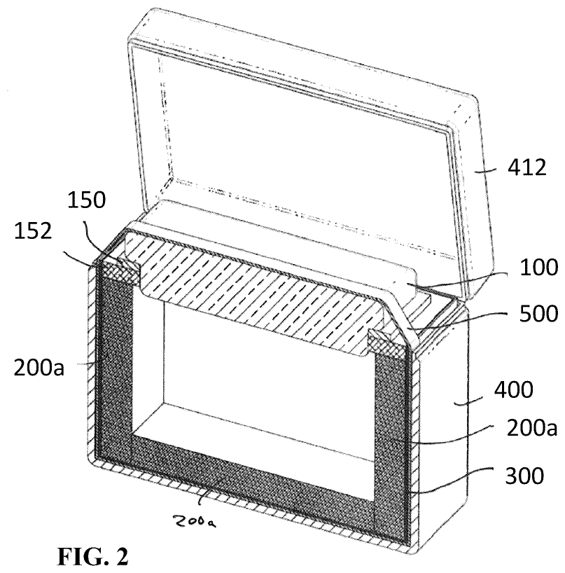

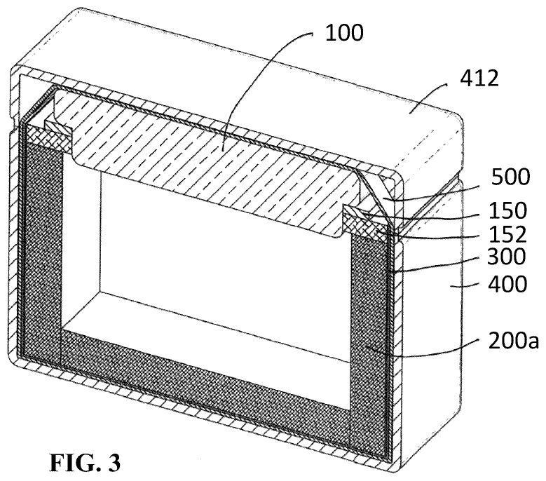

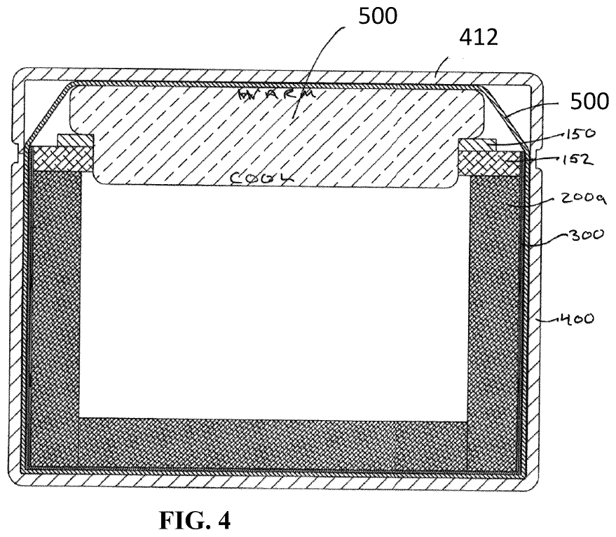

FIG. 2 is a cross-sectional view of the system depicted in FIG. 1, showing the construction layers of the system. Notably, the cooling device 100 is placed in a sealing engagement such that the insulate chamber 200 defines a cooling cavity which is substantially insualted from the outer, heated portion of the system. FIG. 3 depicts a similar cross-section with the outer fabric shell lid 412 in a closed position. As described further below, this lid 412 is designed and configured to aid in heat dissipation to move heat away from the cooling cavity. FIG. 4 is another cross-section view illustrating a system in accordance with some embodiments.

### Insulated Chamber

The insulated chamber itself may be made of any suitable material. It may be formed as one complete, singular unit, or it may be made of a plurality of panels. It may take any shape. A rectangular chamber shape is depicted through the drawings.

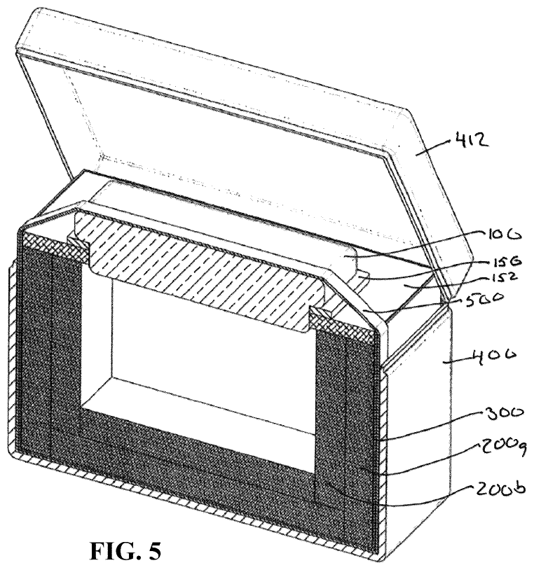

In one particular embodiment, insulative VIP panels are employed, although other insulation, such as but not limited to foams and fiberglass insulation. The insulative panels 200a, create a sidewall and floor of an cavity to be cooled. As shown, four sidewall panels and a floor panel define a cavity therebetween with an open top. The open top defines an upper edge. FIG. 5 depicts a cross-section of an embodiment which include a second additional layer of insulative panels 200b. Additional layers of insulation may be used to improve the insulation value. The type and amount of insulation used can be adjusted to the need.

### Protective Liner

Although the insulative panels used here are contemplated to be rigid, they nevertheless are subject to damage. For example, a pinprick in an insulative VIP panel as contemplated for use herein, significantly impacts their insulative value. Thus, provided herein is a protective layer exterior to the insulated chamber. The protective layer substantially covers the exterior surface of the insulated chamber. The protective layer may be any suitable material, may be separate from on integral with the insulative chamber. For example, corrugated plastic panels could be similarly sized and shaped to match the dimensions of the insulative chamber. Alternatives also include plastic, rubber, foam, or metal panels, sheets, coatings, or containers, again similarly sized and shaped.

### Fabric Outer Shell

To tie it all together, a fabric outer shell 400 is provided exterior to the protective liner 300. As noted, although the protective liner 300 could be a unified structure, it could also be made up of panels. The same is true of the insulated chamber 200. In such instances, the outer fabric shell 400 can be adapted to hold the structure together. This can be accomplished in any suitable manner, including the use of elastic fabric, straps, belts, or other means. In some embodiments the fabric itself will also have protective features. For example and not limitation the fabric may be made of ripstop material, may be reflective (for ease of locating or for reflecting sunlight/heat). The outer fabric shell may include a lid portion, which may or may not be hinged, and could be removably attachable to the lower fabric shell by any suitable means, such as e.g. a zipper.

The exterior of the system described herein may also be provided with any number of other useful features, such as pocket, molle straps, hooks, etc. A should strap(s) and/or handle(s) may also be provided.

### Cooling Device

The system described herein relies on a power-free cooling device. Any suitable cooling device may be employed. Particularly contemplated, however, are cooling devices which provide active cooling, such as evaporative cooling.

As depicted in the various figures, the cooling device 100, is adapted for mounting to an open edge of an insulated chamber. As shown, a gasket 150 is placed between the cooing device 11 and the insulated chamber 200. Shown throughout the figures is an optional adapter 152 which may be employed to make up for any difference in size in the opening versus the cooling device 100. It will be appreciated that an additional gasket can be placed between the optional adaptor and the edge of the insulated chamber. The adapter 152 could be formed as part of the insulated chamber, or made integrally with the cooling device.

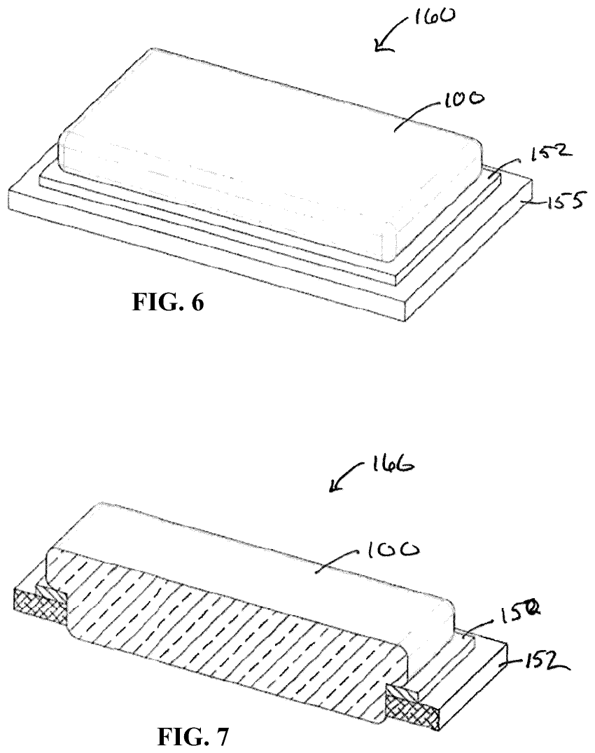

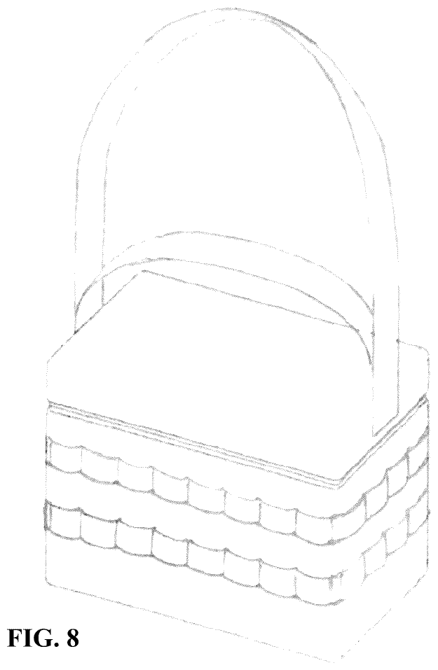

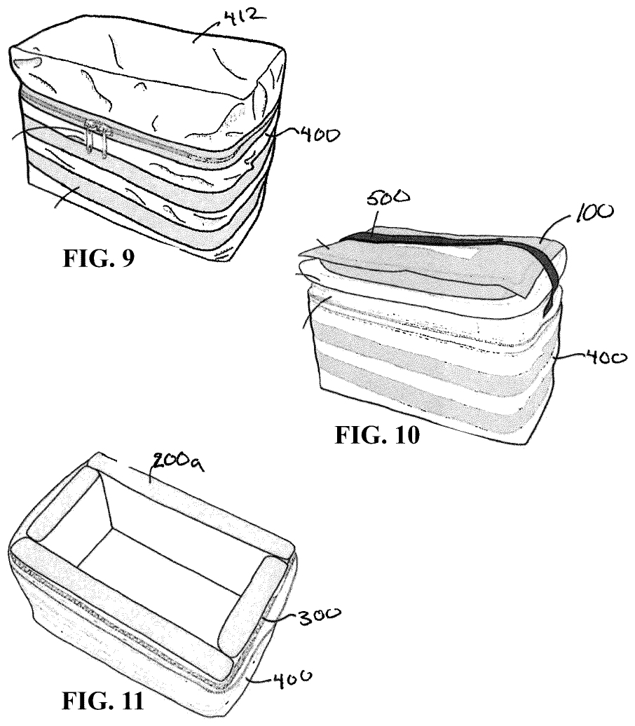

For example, FIGS. 6 and 7 depict a chamber lid 160 for the insulated chamber 200, where the chamber lid incorporates an adapter 152, a gasket 152, and a cooling device 100. As shown, the cooling device 100, is affixed to the adapter 152 with a gasket therebetween. This achieves a good seal against heat infiltration. It will be recognized that the cooling device 100 could include portions specifically adapted to engage and seal the open portions of the insulated chamber. It is contemplated that a sealing member, such as a gasket, is employed to achieve a better seal.

It is further contemplated that a strap 500 or other means is used to hold the cooling device 100 in place, and to exert the required pressure to sealingly engage the gasket 150. The strap may take any suitable form including, but not limited to, an elastic strap, a strap with hook and loop fasteners to adjust and hold in position, a strap with a buckle, snaps, or other. The strap 500 as shown is an elastic band encircling the insulated chamber 200, the protective liner 300, and the cooling device 100 so as to hold it in place. Other arrangements are possible, such as mounting strap ends to the sidewalls of the insulated chamber, protective layer, or even the fabric shell, so long as the strap engages and holds the cooling device in place.

Additionally, the cooling device 100, and related components are adapted such that the warm side of the device is insulated and/or isolated from the cavity to be cooled. Additionally, the other component sparts are designed to allow heat to dissipate out of the system and away from the cavity to enhance cooling characteristics.

### Example Cooling Device and Method

Although the temperature controlled bags, insulated chamber, lids and other parts disclosed herein are suitable for use with any cooling engine, also contemplated herein is an improved cooling engine or cooling device. The present disclosure describes a cooling device for long-duration non-powered cooling, including a reservoir, an evaporator, and an adsorber which includes a metal-organic framework. Methods of cooling an object using such a device are also disclosed.

In some embodiments, there is provided a device for cooling an object. The device includes, in some embodiments, a reservoir which is configured to contain a fluid. In some embodiments, the fluid includes water, acetone, methanol, bromine, cyclohexane, cyclopentane, n-hexane, acetic acid, or combinations thereof. The size of the reservoir is not particularly limited, and may be selected depending on the desired weight of the device, the size of the object to be cooled, and the duration of cooling needed. The object to be cooled is not limited. In some embodiments, the object includes a container, a medical product or device, or a space within the device, wherein the space may be empty. In a typical configuration, the cooling device will be adapted to be affixed to a container, vessel, or other housing defining an interior space, within which an object to be cooled may be placed. In the case where the container is empty, the object to be cooled is the interior space (e.g. air) within container. In turn, objects placed within the container will also be cooled.

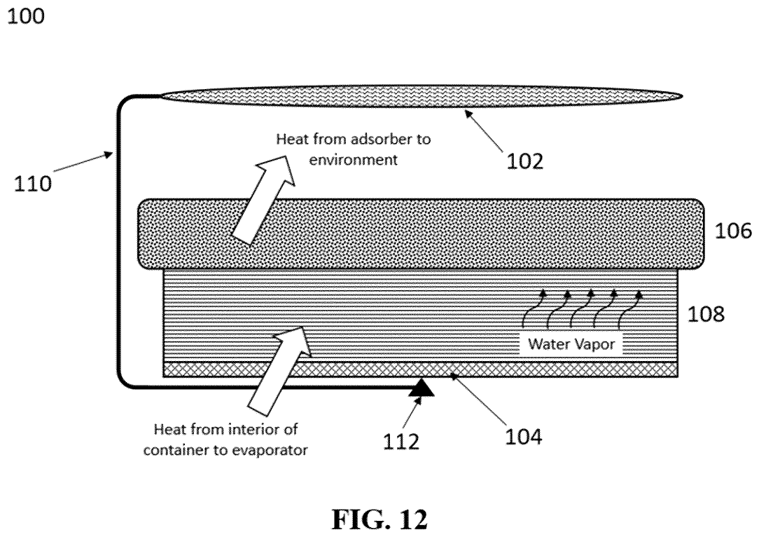

FIG. 12 is an illustrative diagram of a device for cooling an object, according to an embodiment of the present disclosure. In some embodiments, the device 100 includes an evaporator 104. The evaporator 104 may be adjacent to the object to be cooled and may be connected to the reservoir 102 via a conduit 110. The conduit 110 may include one or more of tubes, pipes, wicking material, or other connections known to those skilled in the art. The conduit 110 may include a wicking material through which fluid may enter the evaporator from the reservoir. In some embodiments, the wicking material includes hydrophilic materials such as, but not limited to, microporous metals, porous plastics including polyethylene and polypropylene, adsorbent polymers such as polyacrylamide and sodium polyacrylate, cellulose, other hygroscopic materials, or combinations thereof. Representative wicking materials are described in U.S. Pat. No. 6,688,132, which is incorporated by reference herein in its entirety. In some embodiments, the conduit 110 includes a valve 112. Opening the valve 112 allows fluid to flow from the reservoir 102 to the evaporator 104, and closing the valve stops the fluid from flowing from the reservoir to the evaporator. The valve and the construction of the system, specifically using low permeability materials supports long storage times prior to use without degradation of function.

In some embodiments, the cooling device includes an adsorber 106. The adsorber 106 may be separated from the evaporator 104 by a porous insulating layer 108, allowing vapor to pass through to the adsorber and substantially preventing heat from dissipating back from the adsorber. The porous insulating layer 108 may include fiberglass, porous silica, open cell foams including but not limited to polyurethanes and polystyrenes, and the like. The evaporator, the adsorber, or both the evaporator and the adsorber may be held at a high vacuum.

The adsorber 106 may include a metal-organic framework adsorbent. Metal-organic frameworks are a class of porous materials which include metal ions or clusters coordinated with organic linkers to form structures which typically possess high surface areas with tunable physical and chemical activity. The metal-organic framework of the present disclosure may include zirconium, aluminum, titanium, hafnium, chromium, iron, manganese, indium, or combinations thereof. The metal-organic framework may include organic linkers such as mono-, di-, or tri-carboxylic acids, halide- or nitrogen-substituted aromatics, nitrogen-containing polyaromatics, functionalized porphyrins, or other suitable linker materials which will be familiar to those skilled in the art, or combinations thereof. Examples of suitable linkers include but are not limited to 3,3″,5,5″-tetrakis(4-carboxyphenyl)-p-terphenyl (TCPT), 1,4-benzene dicarboxylate (TPA) (BDC), bis(1H-1,2,3-triazolo[4,5-b],[4′,5′-i])dibenzo-[1,4]dioxin (BTDD), 1,3,5-benzene tricarboxylate (BTC), 1,2,4,5-tetrakis(4-carboxyphenyl)benzene (BTEB), 4,4′,4″,4′″-methanetetrayltetrabenzoate (MTB), 3,5-pyrazoledicarboxylate (PDC), fumarate (FA), 3,3′,5,5′-tetracarboxydiphenylmethane (MDIP), 2,5-thiophenedicarboxylate (TDC), and 2,5-furandicarboxylate (FDC). Specific metal-organic frameworks that may be employed include but are in no way limited to UiO-66, MOF-303, MOF-808, PIZOF-2UiO-66, MIL-101(Cr)PIZOF-2, Cr-soc-MOF-1, MIL-101(Cr), CO2Cl2(BTDD), MIL-100(Fe), MOF-841(Zr), Y-shp-MOF-5, MOF-303(Al), MIL-125(Ti)—NH₂, Aluminum-fumarate, MIP-200(Zr), CAU-23(Al), MIL-53(Al)—OH, MIL-160(Al), CAU-10(Al)—H, UiO-66(Zr), MOF-801(Zr), combinations thereof, or other metal-organic frameworks familiar to those skilled in the art. The adsorber may also be referred to as “the desiccant.”

In some embodiments, the adsorber, which may include a MOF or other desiccant, is prepared on or in combination with a foam, which can aid in maintaining the structure, distribution, and porosity of the adsorber, without wishing to be bound by theory. The foam may be a polymer foam, metal form, non-woven fabric mat made from synthetic or natural fibers, or another porous substrate, as would be familiar to those skilled in the art.

In some embodiments, the adsorber material (e.g. dessicant) has a form factor ranging from nano-scale powder to small granules with diameters in the 1 mm to 5 mm size range. Beds of nano-scale powder may limit mass transport of water vapor. Small granules provide porosity in the bed.

The adsorber may further include a hygroscopic salt. The hygroscopic salt may include calcium chloride (CaCl₂), lithium chloride (LiCl), lithium bromide (LiBr), magnesium chloride (MgCl₂), calcium nitrate (Ca(NO₃)₂), potassium fluoride (KF), phosphorous pentoxide (P₂O₅), magnesium perchlorate (Mg(ClO₄)₂), barium oxide (BaO), calcium oxide (CaO), calcium sulfate (CaSO₄), aluminum oxide (Al₂O₃), calcium bromide (CaBr₂), barium perchlorate (Ba(ClO₄)₂), copper sulfate (CuSO₄) or combinations thereof. The adsorber may also contain silica, wide pore silica or other combinations of adsorbents.

The adsorbent of the present disclosure exhibits a vapor uptake capacity which may be measured or evaluated. Vapor uptake capacity refers to the amount of vapor the adsorbent can adsorb, and is expressed herein in weight percent. For example, an adsorbent which can adsorb an amount of vapor which is equal to the weight of the adsorber would be said to have a vapor uptake capacity of 100 wt. %.

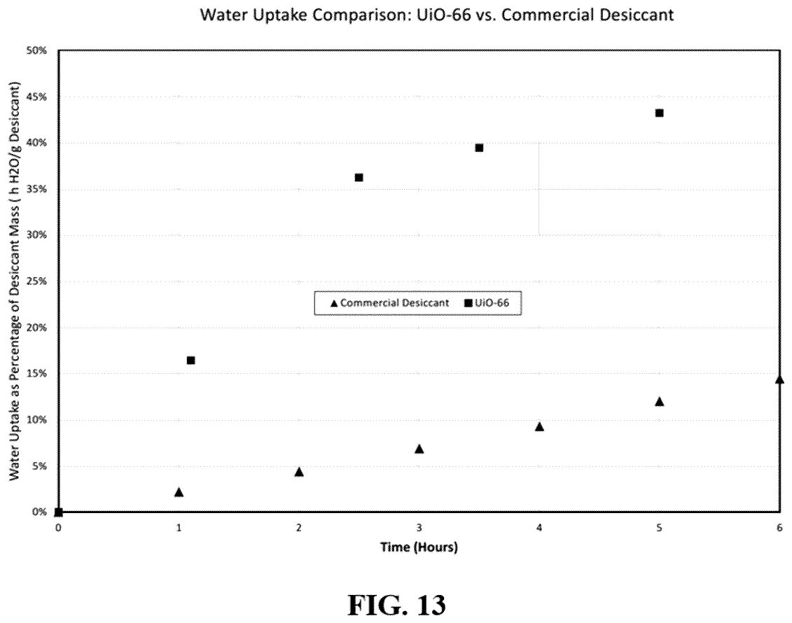

In some embodiments, the adsorbent has a vapor uptake capacity of at least about 35 wt. %, such as at least about 35 wt. %, at least about 40 wt. %, at least about 45 wt. %, at least about 50 wt. %, at least about 55 wt. %, at least about 60 wt. %, at least about 65 wt. %, at least about 70 wt. %, at least about 75 wt. %, at least about 80 wt. %, at least about 90 wt. %, at least about 95 wt. %, at least about 100 wt. %, at least about 110 wt. %, at least about 120 wt. %, at least about 130 wt. %, at least about 140 wt. %, at least about 150 wt. %, at least about 160 wt. %, at least about 170 wt. %, at least about 180 wt. %, at least about 190 wt. %, at least about 200 wt. %, or any range or value contained therein. FIG. 13 is a graph comparing the vapor uptake capacity of a metal-organic framework adsorbent compared to a silica-based adsorbent. As shown, the use of MOF adsorbent provides an improved vapor uptake capacity.

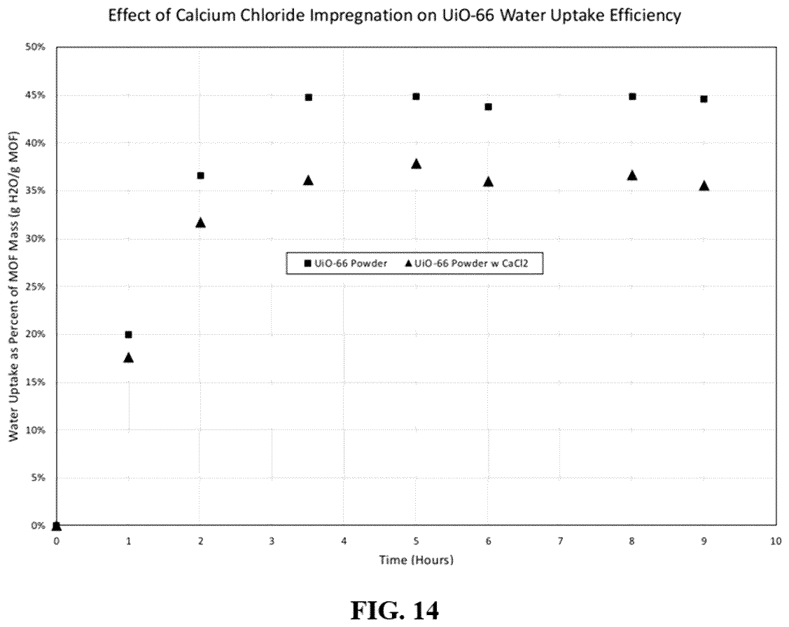

In some embodiments, an adsorber which includes both a metal-organic framework adsorbent and a hygroscopic salt may exhibit a higher vapor uptake capacity than an adsorber which does not include both a metal-organic framework adsorbent and a hygroscopic salt. FIG. 14 is a graph showing the uptake capacity of a metal-organic framework alone compared to a metal-organic framework impregnated with calcium chloride. As shown, the water uptake efficiency of UiO-66, a zirconium-based metal-organic framework, is increased from about 35 wt. % to about 45 wt. %.

In some embodiments, there is provided a method of cooling an object. The method may utilize the cooling device described herein. The method may include steps of providing a fluid in a reservoir, transferring the fluid from the reservoir to an evaporator which is adjacent to the object, the evaporator, under vacuum, evaporates the fluid to form a vapor, thereby lowering the temperature of the fluid in the evaporator which cools the object, and transferring the vapor to an adsorber comprising a metal-organic framework adsorbent which adsorbs the vapor, thereby increasing the temperature of the adsorber, wherein heat is transferred from the adsorber to an environment surrounding the adsorber when the temperature of the adsorber exceeds the temperature of the environment.

In some embodiments, the fluid is water. The reservoir may be a reservoir as described herein; for example, a reservoir configured to contain fluid. The size or material of the reservoir is not particularly limited. The fluid may also be referred to as “the refrigerant.”

Some embodiments provide a cooling container including a cooling device as described above in fluid communication with an interior space defined by a container for housing an object to be cooled. The cooling device is arranged such that heat energy is removed from the interior space, thereby having a cooling effect. The container may be provided with insulation to prolong the cooling effect. In some embodiments, the container is formed from insulating materials including but not limited to vacuum-insulated panels, aerogels, double walled-evacuated structures, and the like. The container may be single-use or multi-use. One or more cooling devices may be employed inside such a container.

In some embodiments, the method includes transferring the fluid from the reservoir to an evaporator. The evaporator may be an evaporator as described herein, such an evaporator that is connected to the reservoir by a conduit and adjacent to the object to be cooled. Transferring the fluid from the reservoir to the evaporator may include opening a valve on the connection between the reservoir and the evaporator, such that the fluid is allowed to flow from the reservoir to the evaporator.

The method includes maintaining a vacuum on the evaporator which evaporates the fluid to form a vapor. Exposure of the fluid in the evaporator to a high vacuum (low pressure) may cause the fluid to evaporate to form a vapor, thereby lowering the temperature of the fluid which remains in the evaporator which cools the object, without wishing to be bound by theory.

In some embodiments, the method includes transferring the vapor to an adsorber comprising a metal-organic framework adsorbent which adsorbs the vapor. The adsorber may be an adsorber as described herein, such as adsorber separated from the evaporator by a porous insulating layer. The vapor passes through the porous insulating layer to the adsorber, where it is adsorbed to the adsorbent's surface. Without wishing to be bound by theory, the adsorption of the vapor increases the temperature of the adsorber and lowers the vapor pressure of the system, thereby causing additional fluid to evaporate, which leads to additional cooling of the object. When the temperature of the adsorber exceeds the temperature of the surrounding environment, heat from the adsorber can be transferred to the environment surrounding the adsorber without being dissipated back to the evaporator or the object. The present design provides a heat pumping path from the space to be cooled to the evaporator, from the evaporator to the adsorber, and from the adsorber to the environment. Without wishing to be bound by theory, the cooling process continues until all of the fluid in the reservoir has been transferred to the evaporator and evaporated, or until all of the adsorption sites of the adsorber have been filled by adsorbed vapor.

The cooling device and method of the present disclosure can provide cooling to the object for a time of about 1 day to about 10 days, such as about 1 day, about 2 days, about 3 days, about 4 days, about 5 days, about 6 days, about 7 days, about 8 days, about 9 days, about 10 days, or any range or value contained therein. It is contemplated that employing a larger system, such as a larger reservoir, and/or a larger adsorber, would permit cooling to be extended beyond 10 days. The present disclosure represents a significant improvement over currently available cooling devices, which are typically limited to 4 days or less. It is thus contemplated that the present cooling device and method provide more than double the cooling duration of current cooling devices, without increasing the size from that of currently available cooling devices.

The cooling device and method of the present disclosure are not connected to a power source, nor do they require external power, meaning that safety and weight concerns associated with batteries and other power sources are eliminated. It is contemplated that any object or environment in need of cooling could be cooled by the cooling device and method of the present disclosure, including blood and blood products, vaccines, and other temperature-sensitive medical or other products.

In some embodiments, there is provided a cooling container, which includes a container defining an interior space to be cooled (which may include an object to be cooled within the interior space) and a cooling device in accordance with any of the embodiments or combination of embodiments disclosed herein. In some embodiments, the cooling device is fluidly connected with the interior space of the container to facilitate cooling the interior space and any contents contained therein.

In some embodiments, the adsorber combines a hygroscopic salt with a super absorbent polymer (SAP), such as sodium polyacrylate, in addition to or instead of the MOF. The hygroscopic salt can, without wishing to be bound by theory, condense vapor and the SAP absorb liquid water before it dissolves the salt. The structure of the system is configured to allow for expansion of the SAP hydrogel.

The amount of fluid (refrigerant) is not particularly limited and may be adjusted according to the needs of a user of the cooling device. Similarly, the amount of adsorber (desiccant) may be adjusted depending on various factors and according to the needs of a user of the cooling device of the present disclosure.

Without wishing to be bound by theory, it is possible to change the size and geometry of the cooling device of the present disclosure. Greater thickness offers the possibility for increased insulation value of the cooling engine and reduced opening in the insulating container to accommodate the cooling engine. It is, in some embodiments, possible to increase the vapor transport capability of the adsorber (desiccant) and/or insulating materials chosen.

In some embodiments, it may be necessary or desirable to increase thermal conduction within the evaporator and adsorber (desiccant bed) by adding macro or micro thermally conductive materials such as metal fins, conductive sheets or fabrics, heat pipes, or mixed in carbon nanotubes. Such embodiments are within the scope of this disclosure.

In some embodiments, the cooling device includes hydrophobic layers to allow water vapor to pass through, but not liquid water.

In some embodiments, the fluid includes fluids instead of or in addition to water, such as acid halides, alcohols, aldehydes, amines, chlorofluorocarbons, esters, ethers, fluorocarbons, perfluorocarbons, halocarbons, halogenated aldehydes, halogenated amines, halogenated hydrocarbons, halomethanes, hydrocarbons, hydrochlorofluorocarbons, hydrofluoroethers, hydrofluoroolefins, inorganic gases, ketones, nitrocarbon compounds, noble gases, organochlorine compounds, organofluorine compounds, organophosphorous compounds, organosilicon compounds, oxide gases, refrigerant blends, thiols, and combinations thereof.

It may be desirable to modify the insulating material (porous insulating layer) to increase or decrease porosity to control adsorption speed or to increase insulating value, without wishing to be bound by theory. New Aerogel formulations and structures may be applicable.

It may be desirable to modify the wicking materials and capillaries connecting the reservoir to the evaporator to increase or decrease wicking speed. In some embodiments, the cooling device includes linear grooving or use of aligned fibers.

In some embodiments, the cooling device includes vapor channels through structure of the adsorber, for example the MOF, and in some embodiments, the adsorber includes other porous materials such as polymer foam to increase vapor pathways.

In some embodiments, the cooling device includes a vacuum chamber to increase vacuum level or decrease rate of vacuum loss.

In some embodiments, the cooling device includes external packaging materials which are configured to decrease permeability or increase durability.

The design of the cooling device of the present disclosure can, in some embodiments, be modified to allow regeneration such that the system can be reused. This can be accomplished by heating the desiccant to evaporate/drive off the adsorbed fluid (which may in some embodiments include water) and condensing the fluid back in its original storage chamber and then closing the connection from the reservoir to the adsorber, so that the cooling process does not start until desired. The evaporated fluid could also be discarded and the reservoir refilled with new fluid. Various modifications may be required to achieve regeneration. Housing materials need to survive external heating, so metals or high temperature polymers or other high temperature materials may be advantageous, in some embodiments. The valve that separates the fluid from the adsorber may be modified such that it can be repeatably opened and closed rather than single use. A method for creating internal vacuum may be employed after the refrigerant is driven off the desiccant. Methods of creating an internal vacuum include a port with a one-way or manual valve with a piston, or other vacuum pump designs. In some embodiments, the method of creating an internal vacuum include an internal pumping mechanism or closing the system while filled with fluid vapor and allowing the adsorber to re-adsorb the vapor, thus creating a vacuum.

The cooling device system may be single use, such that once activated it adsorbs heat and is then disposed of. The cooling device may also be small and portable to facilitate cooling of a portable insulated bag or chamber. Multiple single use cooling devices could be used to achieve additional cooling after the initial cooling engine is exhausted.

### Examples

Metal-organic frameworks have been evaluated for water uptake capacity compared to silica, zeolite, and calcium-chloride, which are commonly used as adsorbents in currently available adsorption cooling systems. Water was used as the fluid in this testing. TABLE 1 below shows the results for vapor uptake of various adsorbent materials and the mass that would be required of each adsorber to achieve 10 days of cooling.

TABLE 1

| | | Adsorber Mass Needed |
|---|---|---|
| | Vapor Uptake (relative to | for 10 Days of Cooling |
| Adsorbent Material | weight of adsorbent) | (g) |
| Silica Gel | 25% | 2440 |
| Zeolite | 30% | 2033 |
| CaCl₂ | 32% | 1906 |
| UiO-66 | 37% | 1649 |
| MOF-303 | 45% | 1356 |
| MOF-808 | 59% | 1034 |
| MIL-101(Cr) | 173% | 353 |

The values in TABLE 1 assume a heat of vaporization of water of 2260 J/g, a water flow rate of 2.5 g/hr, and an initial water mass of 610 g to sustain 10 days of cooling. As shown in TABLE 1 above, silica gel reaches only 25 wt. % vapor uptake and thus would require 2440 g of impregnated silica to achieve 10 days of cooling. Using metal-organic frameworks as an adsorbent increases this value significantly, reaching 173 wt. % with the chromium-based metal-organic framework ML-101(Cr). Additionally, the mass of metal-organic framework adsorbent required to achieve 10 days of cooling is significantly lower than the mass required of silica.

It is contemplated that other MOFs which include different metals and linkers may provide different water uptakes and may be useful in the embodiments disclosed herein. Without wishing to be bound by theory, TABLE 2 includes a variety of metal organic framework adsorbents and their water uptake capacity.

TABLE 2

| MOF | Linker | Water Uptake g/g |
|---|---|---|
| Cr-soc-MOF-1 | TCPT | 1.95 |
| MIL-101(Cr) | BDC | 1.73 |
| C_{O2}Cl2(BTDD) | BTDD | 0.97 |
| MIL-100(Fe) | BTC | 0.79 |
| MOF-808(Zr) | BTC | 0.59 |
| MOF-841(Zr) | MTB | 0.51 |
| Y-shp-MOF-5 | BTEB | 0.48 |
| MOF-303(Al) | PDC | 0.45 |
| MIL-125(Ti)—NH₂ | NH₂-BDC | 0.45 |
| Aluminum-fumarate | FA | 0.45 |
| MIP-200(Zr) | MDIP | 0.45 |
| CAU-23(Al) | TDC | 0.42 |
| MIL-53(Al)—OH | OH-BDC | 0.40 |
| MIL-160(Al) | FDC | 0.38 |
| CAU-10(Al)—H | 1,3-BDC | 0.37 |
| UiO-66(Zr) | BDC | 0.37 |
| MOF-801(Zr) | FA | 0.36 |

The above description describes a temperature controlled bag and a particular cooling device for use therewith. Various additional features to better incorporate an adsorption cooling device into a reusable container/bag are contemplated below. None, all, or any combination of these may be incorporated in the system as needed.

Improved seal between VIPs and cooler without introducing a gap e.g. RTV or other sealant applied to seam (not between VIPS)

Bracket/flange to hold cooler in place relative to insulating walls

Donut shaped VIP to match opening to cooler size and shape

Hinge mechanism to open chamber without removing cooler

Cooler attachment/integration in outer lid for ease of opening

Bag around VIPs to block airflow through cracks, could be vacuumed onto chamber to push VIPs together.

Elastic compression sleeve integrated into bag to close lid tightly or elastic strap(s) inside bag.

VIP readiness indicator (vacuum activated label—e.g. a wrinkle that unfolds to reveal a red line or other indicator if vacuum is lost such as a recessed area that becomes flat or raised when vacuum is lost. This recessed area could be shaped to spell words such as GOOD, BAD, or READY. The transition to flat or raised when vacuum is lost could result from the tension and elasticity of the outer film of the vacuum insulated panel or could be aided by an elastomer or foam inside the chamber that is chosen to provide an outward force that is sufficient force to push the film up to change the indicator, but less than the force applied by the vacuum pressure relative to abient pressure, i.e. force=pressure×area.))

### Integrated Temperature Monitoring

Heat Pipe within Chamber to Prevent Stratification

Combination of PCM and cooler to more precisely control temperature, prevent overcooling

Heating system for cold temperature use by flipping over the cooling engine

Increased conductivity/airflow patch on top of adsorber in case/bag

Spacer to prevent direct cooler contact with product that could result in overcooling

It should be noted the system is particularly adapted for maintaining the temperature of materials such as blood that must be stored in a limited temperature range (2 C to 6 C for blood).

### Adsorption Cooler Improvement Concepts:

Thermostat control of heat flow using a shape changing element to control flow restriction, e.g. paraffin wax expands to compress capillary channels, nitinol bends or compresses channels, gas chamber compresses allowing mechanical spring or flexure to push on capillaries, etc. The temperature of the evaporator may be controlled using a device that passively restricts the flow the fluid as the temperature decreases, thereby reducing the rate of evaporation. This could be due to increasing fluid viscosity, fluid phase change from liquid to solid, of by the action of an external thermally actuated subcomponent.

Electronic Thermostat Control Leveraging Temperature Monitoring/Tracking Device that is Often Required
Integration of VIP or Aerogel into Cooler to Improve Insulation Between Evaporator and Adsorber

Improvements for operation at lower temperatures, e.g. −20 C

Control/distribution of glycol or other additives, special desiccant design. Appropriate liquid-adsorbent pair—Activated Carbon could be used to adsorb hydrocarbon vapor

Evaporator wicking material that prevents freezing. Superhydrophobic. w

### Improvements to the Two-Stage Concept

Specific fluid desiccant combinations include Hexane, toluene, ethanol, propanol, acetone, ethylene glycol with activated carbon. All evaporate at temperatures below OC. Mixtures with water also possible.

Cooling engine percent remaining indicator—e.g. color changing. This may be accomplished with a clear window on the warm side to show a color change to indicate that desiccant has been exhausted.

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55%.

As used herein, the term “vacuum” refers to a pressure that is lower than standard atmospheric pressure, i.e., vacuum conditions. “High vacuum” refers to pressures that are significantly lower than atmospheric pressure and can include pressures that are close to zero absolute pressure.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 cells refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A temperature controlled bag comprising:
an unpowered cooling device,
a bag, comprising
an insulated chamber defining a cavity to be cooled,
a protective layer exterior to the insulated chamber, and
an outer fabric shell,
wherein the cooling device is mounted to edges at an opening of the insulated chamber with a sealing gasket therebetween, and
a strap used to secure the cooling device in place with a sealing amount of pressure to engage the gasket.

2. The temperature controlled bag of claim 1, further comprising an adapter between the cooling engine and the insulated chamber to accommodate differences in size

3. The temperature controlled bag of claim 1, wherein the unpowered cooling device is an adsorptive cooler capable of maintaining blood preservation temperatures for at least 3 days.

4. The temperature controlled bag of claim 1, wherein the insulative chamber further comprises one or more VIP panels.

5. The temperature controlled bag of claim 1, wherein the protective layer comprises a material having one or more of the following features: shock resistance, puncture resistance, water resistance, chemical resistance, and rip stop.

6. The temperature controlled bag of claim 1, further comprising
an adapter between the cooling engine and the insulated chamber to accommodate differences in size; and
wherein the unpowered cooling device is an absorptive cooler capable of maintaining blood preservation temperatures for at least 3 days;
the insulative chamber further comprises one or more VIP panels; and
the protective layer comprises a material having one or more of the following features: shock resistance, puncture resistance, water resistance, chemical resistance, and rip stop.

7. A cooling device for cooling an object, comprising:
a reservoir configured to contain a fluid,
an evaporator adjacent to an object to be cooled, and
an adsorber comprising a metal-organic framework adsorbent,
wherein the cooling device is not connected to a power source.

8. The cooling device of claim 7, wherein the fluid comprises water.

9. The cooling device of claim 7, wherein the reservoir is connected to the evaporator by a conduit including a wicking material.

10. The cooling device of claim 9, wherein the conduit further comprises a valve.

11. The cooling device of claim 7, wherein the metal-organic framework adsorbent comprises zirconium, aluminum, titanium, hafnium, chromium, iron, manganese, indium, 3,3″,5,5″-tetrakis(4-carboxyphenyl)-p-terphenyl, 1,4-benzene dicarboxylate (TPA), bis(1H-1,2,3-triazolo[4,5-b],[4′,5′-i])dibenzo-[1,4]dioxin, 1,3,5-benzene tricarboxylate, 1,2,4,5-tetrakis(4-carboxyphenyl)benzene, 4,4′,4″,4′″-methanetetrayltetrabenzoate, 3,5-pyrazoledicarboxylate, fumarate, 3,3′,5,5′-tetracarboxydiphenylmethane, 2,5-thiophenedicarboxylate, 2,5-furandicarboxylate, or combinations thereof.

12. The cooling device of claim 7, wherein the metal organic framework adsorbent comprises UiO-66, MOF-303, MOF-808, PIZOF-2UiO-66, MIL-101(Cr)PIZOF-2, Cr-soc-MOF-1, MIL-101(Cr), CO2Cl2(BTDD), MIL-100(Fe), MOF-841(Zr), Y-shp-MOF-5, MOF-303(Al), MIL-125(Ti)—NH₂, Aluminum-fumarate, MIP-200(Zr), CAU-23(Al), MIL-53(Al)—OH, MIL-160(Al), CAU-10(Al)—H, UiO-66(Zr), MOF-801(Zr), or combinations thereof.

13. The cooling device of claim 7, wherein the adsorbent further comprises a hygroscopic salt.

14. The cooling device of claim 13, wherein the hygroscopic salt comprises calcium chloride (CaCl₂), lithium chloride (LiCl), lithium bromide (LiBr), magnesium chloride (MgCl₂), calcium nitrate (Ca(NO₃)₂), potassium fluoride (KF), phosphorous pentoxide (P₂O₅), magnesium perchlorate (Mg(ClO₄)₂), barium oxide (BaO), calcium oxide (CaO), calcium sulfate (CaSO₄), aluminum oxide (Al₂O₃), calcium bromide (CaBr₂), barium perchlorate (Ba(ClO₄)₂), copper sulfate (CuSO₄), or combinations thereof.

15. The cooling device of claim 7, wherein the adsorber has a vapor uptake capacity of at least about 60 wt. %.

16. The cooling device of claim 7, wherein the adsorber has a vapor uptake capacity of at least about 90 wt. %.

17. The cooling device of claim 7, wherein the adsorber is separated from the evaporator by a porous insulating layer.

18. A method of operating the cooling device of claim 7, comprising:
transferring the fluid from the reservoir to the evaporator,
wherein the evaporator, which is under vacuum, evaporates the fluid to form a vapor, thereby lowering the temperature of the fluid in the evaporator which cools the object, and
transferring the vapor to an adsorber comprising a metal-organic framework which adsorbs the vapor, thereby increasing the temperature of the adsorber,
wherein heat is transferred from the adsorber to an environment surrounding the adsorber when the temperature of the adsorber exceeds the temperature of the environment.

19. A method of cooling an object, comprising:
providing a fluid in a reservoir,
transferring the fluid from the reservoir to an evaporator which is adjacent to the object,
wherein the evaporator, which is under vacuum, evaporates the fluid to form a vapor, thereby lowering the temperature of the fluid in the evaporator which cools the object, and
transferring the vapor to an adsorber comprising a metal-organic framework adsorbent which adsorbs the vapor, thereby increasing the temperature of the adsorber,
wherein heat is transferred from the adsorber to an environment surrounding the adsorber when the temperature of the adsorber exceeds the temperature of the environment.

20. The method of claim 19, wherein the fluid is water.

21. The method of claim 19, wherein the metal-organic framework adsorbent comprises zirconium, aluminum, titanium, hafnium, chromium, iron, manganese, indium, 3,3″,5,5″-tetrakis(4-carboxyphenyl)-p-terphenyl, 1,4-benzene dicarboxylate (TPA), bis(1H-1,2,3-triazolo[4,5-b],[4′,5′-i])dibenzo-[1,4]dioxin, 1,3,5-benzene tricarboxylate, 1,2,4,5-tetrakis(4-carboxyphenyl)benzene, 4,4′,4″,4′″-methanetetrayltetrabenzoate, 3,5-pyrazoledicarboxylate, fumarate, 3,3′,5,5′-tetracarboxydiphenylmethane, 2,5-thiophenedicarboxylate, 2,5-furandicarboxylate, or combinations thereof.

22. The method of claim 19, wherein the metal organic framework adsorbent comprises UiO-66, MOF-303, MOF-808, PIZOF-2UiO-66, MIL-101(Cr)PIZOF-2, Cr-soc-MOF-1, MIL-101(Cr), CO2Cl2(BTDD), MIL-100(Fe), MOF-841(Zr), Y-shp-MOF-5, MOF-303(Al), MIL-125(Ti)—NH₂, Aluminum-fumarate, MIP-200(Zr), CAU-23(Al), MIL-53(Al)—OH, MIL-160(Al), CAU-10(Al)—H, UiO-66(Zr), MOF-801(Zr), or combinations thereof.

23. The method of claim 19, wherein the adsorbent further comprises a hygroscopic salt.

24. The method of claim 19, wherein the hygroscopic salt comprises calcium chloride (CaCl₂), lithium chloride (LiCl), lithium bromide (LiBr), magnesium chloride (MgCl₂), calcium nitrate (Ca(N03)₂), potassium fluoride (KF), phosphorous pentoxide (P₂O₅), magnesium perchlorate (Mg(ClO₄)₂), barium oxide (BaO), calcium oxide (CaO), calcium sulfate (CaSO₄), aluminum oxide (Al₂O₃), calcium bromide (CaBr₂), barium perchlorate (Ba(ClO₄)₂), copper sulfate (CuSO₄), or combinations thereof.

25. The method of claim 19, wherein the adsorbent has a vapor uptake capacity of at least about 60 wt. %.

26. The method of claim 19, wherein the adsorbent has a vapor uptake capacity of at least about 90 wt. %.

27. The method of claim 19, wherein the object can be cooled for a time of about 1 day to about 10 days.

28. The method of claim 19, wherein cooling of the object ends when the reservoir is emptied of fluid.

29. The method of claim 19, wherein cooling of the object does not utilize a power source.
